(19) United States
(12) Patent Application Publication
(10) Pub. No.: US 2016/0150345 A1
(43) Pub. Date: May 26, 2016

(54) METHOD AND APPARATUS FOR CONTROLLING SOUND USING MULTIPOLE SOUND OBJECT

(71) Applicant: Electronics and Telecommunications Research Institute, Daejeon (KR)

(72) Inventor: Dae Young JANG, Daejeon (KR)

(21) Appl. No.: 14/950,072

(22) Filed: Nov. 24, 2015

(30) Foreign Application Priority Data
Nov. 24, 2014 (KR) 10-2014-0164512
Jun. 19, 2015 (KR) 10-2015-0087719

(51) Int. Cl. H04S 7/00

(52) U.S. Cl. CPC H04S 7/302; H04S 2400/11; H04S 2400/13; H04S 2400/03

(57) ABSTRACT

Disclosed is a method and apparatus for controlling a sound to be provided to a user based on a multipole sound object, the method including setting a multipole sound object including at least one sound source, and controlling an attribute of a sound source included in the multipole sound object based on a direction and a relative distance between the multipole sound object and the user.

### CROSS-REFERENCE TO RELATED APPLICATION

This application claims the priority benefit of Korean Patent Application No. 10-2014-0164512 filed on Nov. 24, 2014 and Korean Patent Application No. 10-2015-0087719 filed on Jun. 19, 2015, in the Korean Intellectual Property Office, the disclosures of which are incorporated herein by reference.

### BACKGROUND

1. Field of the Invention Embodiments relate to a method and apparatus for controlling a sound to be provided to a user using a multipole sound object.

2. Description of the Related Art

Object based audio technology may be technology for replaying a position of a sound source according to a moving route of the sound source in a playback operation by expressing a sound object as a point sound source and location information associated with the point sound source.

A sound object, for example, a vehicle, having a volume may include a plurality of differing sound sources. When a relative distance between the sound object and a user is shorter than a predetermined distance, a sound may vary for each direction and thus, the sound object may be inaccurately expressed using the point sound source, a monopole sound source.

To express the sound object having a volume, a patent “Method of generating and consuming 3D audio scene with extended spatiality of sound source” has been filed in 2002 by Electronics and Telecommunications Research Institute (ETRI). In the method of generating and consuming 3D audio scene with extended spatiality of sound source, x, y, and z coordinates may be used to express an area or a volume of the sound object in a multidimensional space and a direction of a directional vector perpendicular to a plane thereof. Thus, the method may be, for example, a method of extending one point sound source through a replication having a low correlation. Since the one point sound source is replicated, it is difficult to represent the sound object having the volume and including the plurality of differing sound sources in practice.

Accordingly, there is a desire for a method of representing a sound object having a volume and including a plurality of differing sound sources.

### SUMMARY

An aspect provides a method and apparatus for accurately representing a realistic sound of a sound object having a volume using a multipole sound object.

According to an aspect, there is provided a sound control method including setting a multipole sound object including at least one sound source, and controlling an attribute of a sound source included in the multipole sound object based on a direction and a relative distance between the multipole sound object and a user.

The setting may include setting the multipole sound object based on a sound source and at least one directional characteristic of the sound source.

When the multipole sound object rotates, the controlling may include rotating a position of the sound source and a directional characteristic of the sound source based on a center of the multipole sound object.

When the multipole sound object rotates based on the user, the controlling may include moving a position of the sound source and a directional characteristic of the sound source based on a position to which the multipole sound object rotates.

When the relative distance between the multipole sound object and the user changes, the controlling may include moving a position of the sound source and a directional characteristic of the sound source based on a change in the relative distance between the multipole sound object and the user.

The setting may include arranging a plurality of sound sources based on a position of the multipole sound object and setting the multipole sound object using directional characteristics of the sound sources.

The controlling may include controlling a relative distance of the plurality of sound sources to control a volume of the multipole sound object.

When the relative distance between the multipole sound object and the user exceeds a threshold, the controlling may include downmixing the plurality of sound sources to be one sound source and expressing the multipole sound object based on the one sound source and at least one directional characteristic of the one sound source.

The setting may include setting the multipole sound object in a form of a line source by arranging a plurality of sound sources in a one-dimensional (1D) form.

The setting may include setting the multipole sound object in a form of a plane source by arranging a plurality of sound sources in a two-dimensional (2D) form.

The setting may include setting the multipole sound object in a form of a volume source by arranging a plurality of sound sources in a three-dimensional (3D) form.

According to another aspect, there is also provided a sound control apparatus including a multipole sound object setter configured to set a multipole sound object including at least one sound source, and a sound source controller configured to control an attribute of a sound source included in the multipole sound object based on a direction and a relative distance between the multipole sound object and a user.

The multipole sound object setter may be configured to set the multipole sound object based on a sound source and at least one directional characteristic of the sound source.

When the multipole sound object rotates, the sound source controller may be configured to rotate a position of the sound source and a directional characteristic of the sound source based on a center of the multipole sound object.

When the multipole sound object rotates based on the user, the sound source controller may be configured to move a position of the sound source and a directional characteristic of the sound source based on a position to which the multipole sound object rotates.

When the relative distance between the multipole sound object and the user changes, the sound source controller may be configured to move a position of the sound source and a directional characteristic of the sound source based on a change in the relative distance between the multipole sound object and the user.

The multipole sound object setter may be configured to arrange a plurality of sound sources based on a position of the multipole sound object and set the multipole sound object based on directional characteristics of the sound sources.

The sound source controller may be configured to control a relative distance of the plurality of sound sources to control a volume of the multipole sound object.

When the relative distance between the multipole sound object and the user exceeds a threshold, the sound source controller may be configured to downmix the plurality of sound sources to be one sound source and express the multipole sound object based on the one sound source and at least one directional characteristic of the one sound source.

The multipole sound object setter may be configured to set the multipole sound object in a form of a volume source by arranging a plurality of sound sources in a three-dimensional (3D) form.

### BRIEF DESCRIPTION OF THE DRAWINGS

These and/or other aspects, features, and advantages of the disclosure will become apparent and more readily appreciated from the following description of embodiments, taken in conjunction with the accompanying drawings of which:

FIG. 1 is a block diagram illustrating a sound control apparatus according to an embodiment;

FIG. 2 illustrates an example of a multipole sound object according to an embodiment;

FIG. 3 illustrates an example of a multipole sound object rotating based on a user according to an embodiment;

FIG. 4 illustrates an example of a rotation of a multipole sound object according to an embodiment;

FIG. 5 illustrates an example of decreasing a relative distance between a user and a multipole sound object according to an embodiment;

FIG. 6 illustrates an example of changing a relative distance between sound sources included in a multipole sound object according to an embodiment;

FIG. 7 illustrates an example of decreasing a relative distance between a user and a multipole sound object and changing a relative distance between sound sources included in the multipole sound object according to an embodiment;

FIG. 8 illustrates an example of increasing a relative distance between a user and a multipole sound object according to an embodiment;

FIG. 9 illustrates another example of a multipole sound object according to an embodiment;

FIG. 10 illustrates an example of an actual object corresponding to a multipole sound object according to an embodiment; and

FIG. 11 is a flowchart illustrating a sound control method according to an embodiment.

### DETAILED DESCRIPTION

Reference will now be made in detail to embodiments of the present disclosure, examples of which are illustrated in the accompanying drawings, wherein like reference numerals refer to the like elements throughout. A sound control method according to example embodiments may be performed by a sound control apparatus.

In object based sound control technology for a realistic sound, an object sound source may not be determined as an only signal with respect to a position of the object sound. As an example, in a vehicle, a plurality of differing sounds such as engine noise and an exhaust sound generated in the vehicle may be recognized as a vehicular sound. Also, a user may differently recognize the vehicular sound based on a relative distance between the user and the vehicle. For example, when the user is located in front of the vehicle, the user may recognize that the engine noise is louder than the exhaust sound.

Thus, when a monopole sound source acquired at a fixed position is used as an object sound corresponding to the vehicle, the vehicular sound may be recognized to be the same irrespective of the relative distance between the user and the vehicle and thus, a sense of reality may decrease.

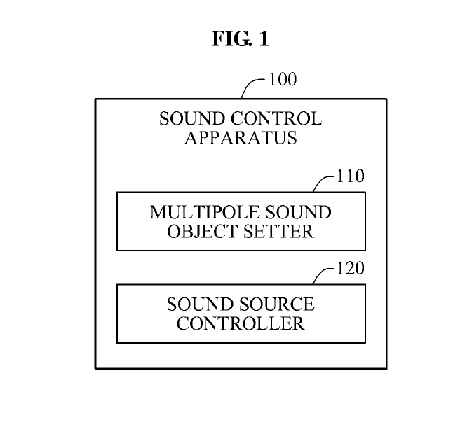

A sound control apparatus 100 according to an example embodiment may set a sound object, for example, a vehicle, having a volume and including a plurality of sound sources to be a multipole sound object and control the multipole sound object, thereby providing a realistic sound based on a relative distance between a user and the multipole sound object. FIG. 1 is a block diagram illustrating the sound control apparatus 100 according to an embodiment.

The sound control apparatus 100 may provide a sound naturally changing based on a distance and a direction when a mobile sound source or an interactive sound source using object based sound control technology in which a monopole sound object signal is extended to be a multipole sound object signal.

Referring to FIG. 1, the sound control apparatus 100 may include a multipole sound object setter 110 and a sound source controller 120.

The multipole sound object setter 110 may set a multipole sound object including at least one sound source.

In this example, the multipole sound object setter 110 may set the multipole sound object based on a sound source and at least one directional characteristic of the sound source. A directional characteristic may be indicated by a direction, an amplitude, and a directivity pattern of a main lobe. Also, the directional characteristic of the sound source may be expressed by a gain value of each direction.

The multipole sound object setter 110 may arrange a plurality of sound sources included in the multipole sound object based on a position of the multipole sound object, and set the multipole sound object based on a directional characteristic for each of the sound sources. In this example, a number of sound sources arranged based on the position of the multipole sound object may be changeably determined as necessary.

The multipole sound object setter 110 may set the multipole sound object in a form of a line source by arranging the plurality of sound sources in a one-dimensional (1D) form.

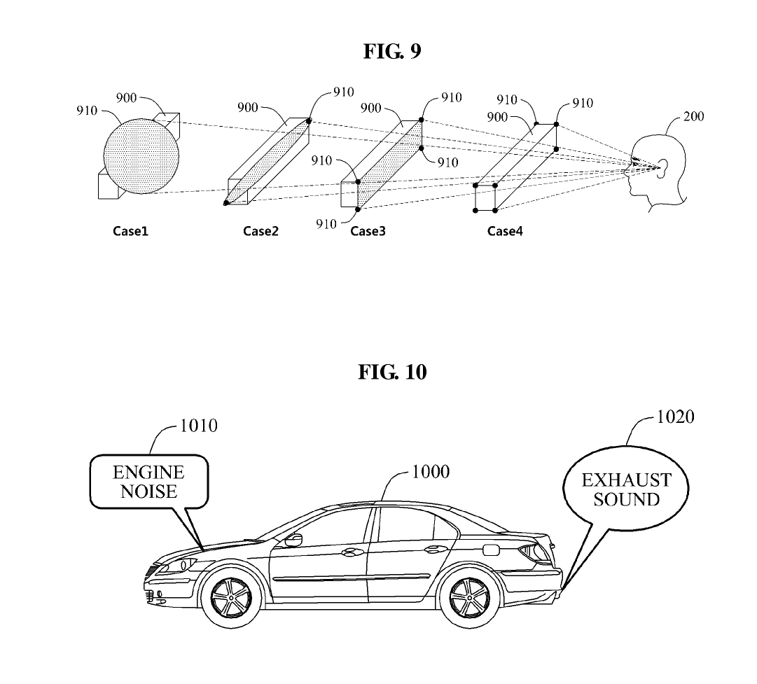

The multipole sound object setter 110 may set the multipole sound object in form of a plane source by arranging the plurality of sound sources in a two-dimensional (2D) form. Also, the multipole sound object setter 110 may set the multipole sound object in a volume source by arranging the plurality of sound sources in a three-dimensional (3D) form. Descriptions related to an example of the multipole sound object setter 110 arranging the plurality of sound sources will be provided with reference to FIG. 9.

The sound source controller 120 may control an attribute of the sound source included in the multipole sound object based on a direction and a relative distance between the multipole sound object and a user. In this example, the sound source controller 120 may control the attribute by controlling a directional characteristic and a position of the sound source and a relative distance between the sound sources based on a rotation of the multipole sound object, a position to which the multipole sound object rotates based on the user, and a change in the relative distance between the user and the multipole sound object.

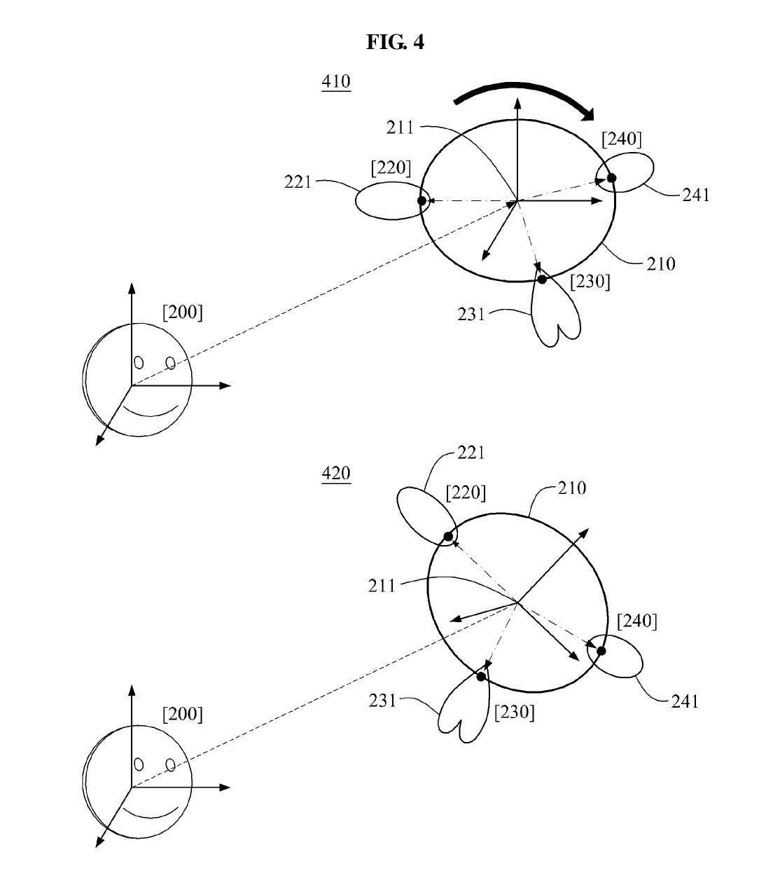

As an example, when the multipole sound object rotates, the sound source controller 120 may rotate the directional characteristic and the position of the sound source based on a center of the multipole sound object. Descriptions related to an operation performed when the multipole sound object rotates will be provided as an example with reference to FIG. 4.

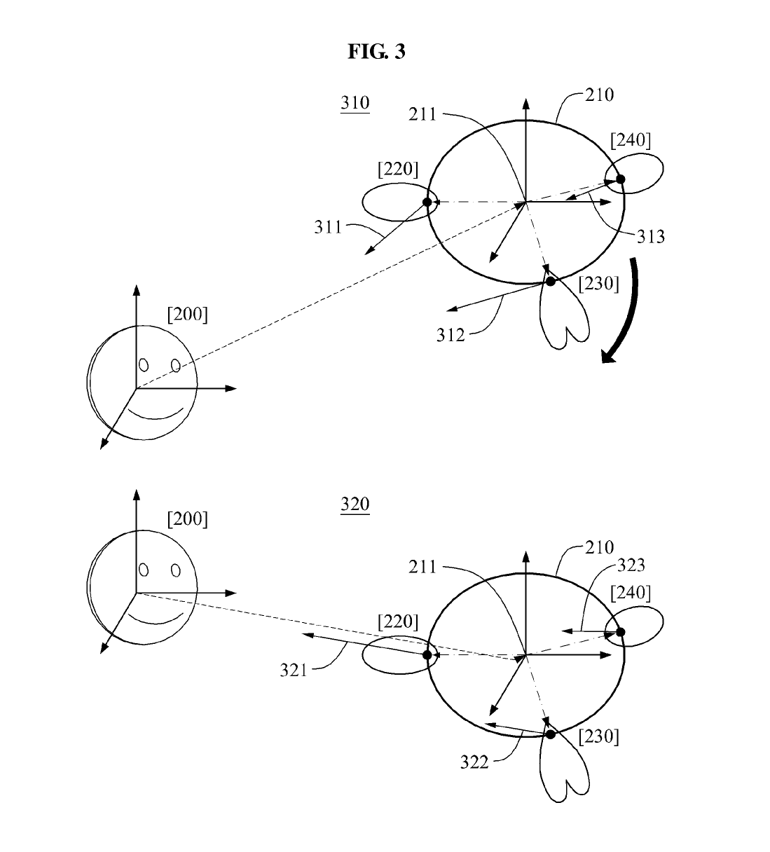

When the multipole sound object rotates based on the user, the sound source controller 120 may move the position and the directional characteristic of the sound source based on the position to which the multipole sound object rotates. In this example, the sound source controller 120 may move the directional characteristic and the position of the sound source based on the position to which the multipole sound object rotates based on the user as illustrated in FIG. 3.

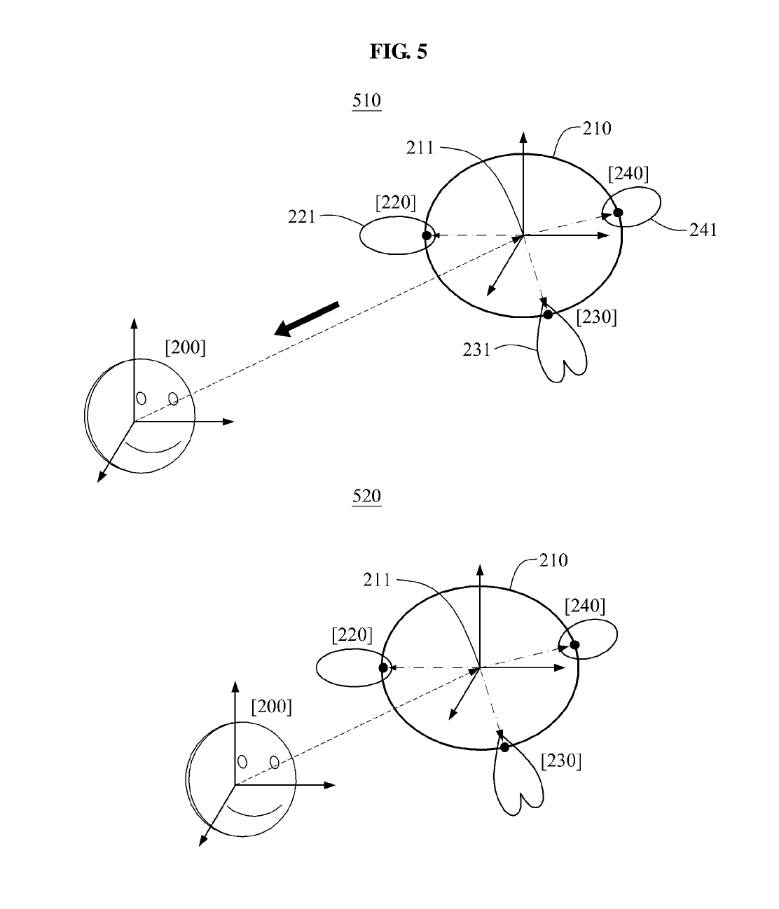

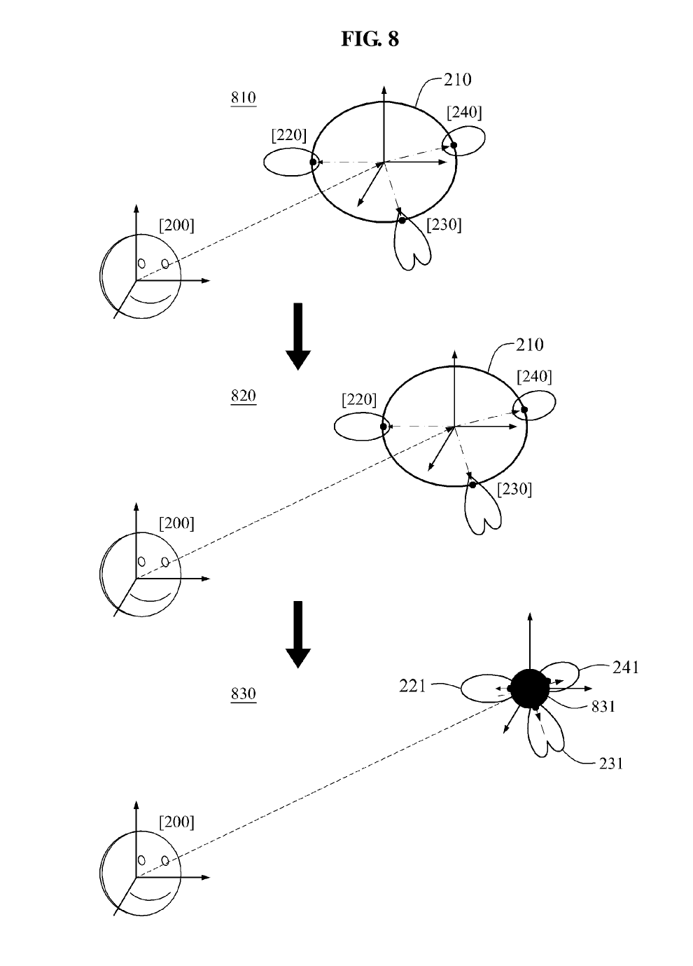

When the relative distance between the user and the multipole sound object changes, the sound source controller 120 may move the directional characteristic and the position of the sound source based on a change in the relative distance between the user and the multipole sound object. In this example, when the relative distance between the user and the multipole sound object decreases, the sound source controller 120 may move the directional characteristic and the position of the sound source as illustrated in FIG. 5. When the relative distance between the user and the multipole sound object increases, the sound source controller 120 may move the directional characteristic and the position of the sound source as illustrated in FIG. 8. Also, when the relative distance between the user and the multipole sound object exceeds a threshold, the sound source controller 120 may downmix the plurality of sound sources to be one sound source, and express the multipole sound object based on the one sound source and at least one directional characteristic of the one sound source.

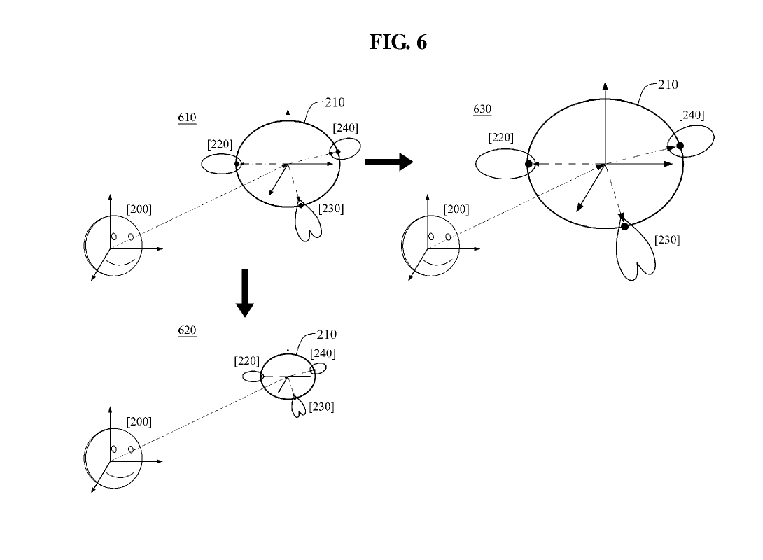

The sound source controller 120 may control a volume of the multipole sound object by controlling the relative distance of the plurality of sound sources. Descriptions related to an example of controlling the volume of the multipole sound object will be provided with reference to FIG. 6.

The sound control apparatus 100 may set the multipole sound object based on a hierarchical structure and thus, express a special effect of exploring an inside of a sound object, for example, a vehicle, having a volume and including a plurality of sound sources. For example, in an orchestra, the sound control apparatus 100 may move beside a conductor and players and provide a listenable sound at a relocated position.

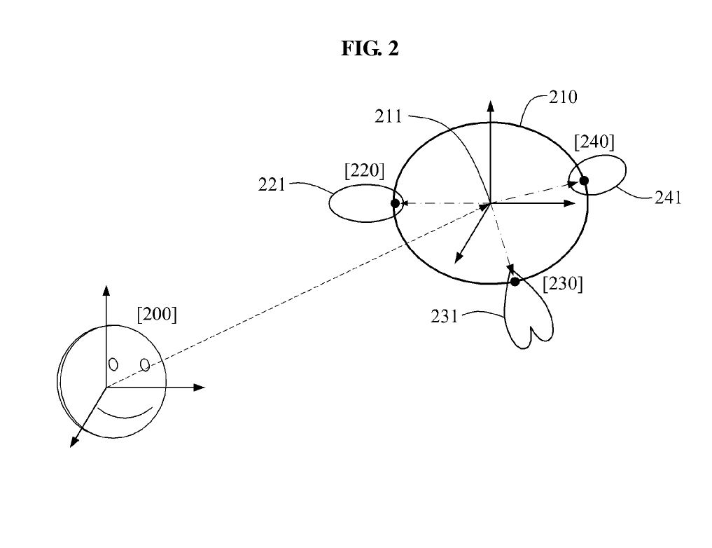

FIG. 2 illustrates an example of a multipole sound object 210 according to an embodiment.

Referring to FIG. 2, the multipole sound object setter 110 may set a multipole sound object 210 having a volume at a predetermined position relative to a user 200. Also, the multipole sound object setter 110 may arrange a plurality of sound sources 220, 230, and 240 included in the multipole sound object 210 based on a center 211 of the multipole sound object 210. In this example, each of the sound sources 220, 230, and 240 may have a relative position based on the center 211. Also, the sound sources 220, 230, and 240 may have directivity patterns 221, 231, and 241, respectively.

The multipole sound object setter 110 may indicate positions of the sound sources 220, 230, and 240, and the center 211 of the multipole sound object 210 based on a rectangular coordinate system using x, y, and z axes, and a spherical coordinate system using r, θ, and φ axes.

The sound source controller 120 may control the sound sources 220, 230, and 240, and the directivity patterns 221, 231, and 241 of the sound sources 220, 230, and 240 based on a direction and a relative distance between the multipole sound object 210 and the user 200. Through this, the sound source controller 120 may generate a sound in which a directivity and relative distances of the sound sources 220, 230, and 240 vary based on a direction of the multipole sound object 210.

FIG. 3 illustrates an example of the multipole sound object 210 rotating based on a user according to an embodiment.

Referring to FIG. 3, the multipole sound object 210 may rotate clockwise based on the user 200. In this example, the multipole sound object 210 may move from a position indicated in a portion 310 to a position indicated in a portion 320.

In FIG. 3, the sound source controller 120 may move the sound sources 220, 230, and 240 while maintaining relative positions between the sound sources 220, 230, and 240 and the center 211 of the multipole sound object 210. For example, relative positions between the sound sources 220, 230, and 240 and the center 211 of the multipole sound object 210 in the portion 310 may be the same as relative positions between the sound sources 220, 230, and 240 and the center 211 of the multipole sound object 210 in the portion 320.

Relative directions between the sound sources 220, 230, and 240 and the user 200 may change in response to a movement of the multipole sound object 210. Thus, a gain based on the directivity patterns 221, 231, and 241 of the sound sources 220, 230, and 240 may also change. In this example, the gain may be determined based on an angular difference between virtual lines connecting the user 200 and the multipole sound object 210, and directions of the directivity patterns 221, 231, and 241.

As an example, an angle between the user 200 and the direction of the directivity pattern 221 of the sound source 220 in the portion 310 may differ from an angle between the user 200 and the direction of the directivity pattern 221 in the portion 320. Thus, as illustrated in FIG. 3, a gain 311 of the directivity pattern 221 of the sound source 220 in the portion 310 may differ from a gain 321 of the directivity pattern 221 in the portion 320.

Additionally, an angle between the user 200 and the direction of the directivity pattern 231 of the sound source 230 in the portion 310 may differ from an angle between the user 200 and the direction of the directivity pattern 231 in the portion 320. Thus, as illustrated in FIG. 3, a gain 312 of the directivity pattern 231 of the sound source 230 in the portion 310 may differ from a gain 322 of the directivity pattern 231 in the portion 320.

Also, an angle between the user 200 and the direction of the directivity pattern 241 of the sound source 240 in the portion 310 may differ from an angle between the user 200 and the direction of the directivity pattern 241 in the portion 320. Thus, as illustrated in FIG. 3, a gain 313 of the directivity pattern 241 of the sound source 240 in the portion 310 may differ from a gain 323 of the directivity pattern 241 in the portion 320.

In this example, the sound sources 220, 230, and 240 may be combined with one another based on the changed gains 321, 322, and 323 so as to provide, to the user 200, a sound corresponding to the multipole sound object 210 at the position indicated in the portion 320.

FIG. 4 illustrates an example of a rotation of the multipole sound object 210 according to an embodiment.

In response to a rotation of the multipole sound object 210, the sound source controller 120 may move the sound sources 220, 230, and 240 from a position indicated in a portion 410 to a position indicated in a portion 420. For example, the sound source controller 120 may rotate positions of the sound sources 220, 230, and 240 based on the center 211 of the multipole sound object 210.

In this example, relative directions between the sound sources 220, 230, and 240 and the user 200 may change in response to a positional change of the sound sources 220, 230, and 240. Thus, gains based on the directivity patterns 221, 231, and 241 of the sound sources 220, 230, and 240 may also change.

Also, the sound sources 220, 230, and 240 may be combined with one another based on the changed gains of the directivity patterns 221, 231, and 241 of the sound sources 220, 230, and 240 so as to provide, to the user 200, a sound corresponding to the multipole sound object 210 rotated as shown in the portion 320.

FIG. 5 illustrates an example of decreasing a relative distance between the user 200 and the multipole sound object 210 according to an embodiment.

When the multipole sound object 210 moves from a position indicated in a portion 510 to a position indicated in a portion 520, a relative distance between the user 200 and the multipole sound object 210.

Referring to FIG. 5, the sound source controller 120 may move the sound sources 220, 230, and 240 while maintaining relative positions between the center 211 of the multipole sound object 210 and the sound sources 220, 230, and 240. For example, relative positions between the sound sources 220, 230, and 240 and the center 211 of the multipole sound object 210 in the portion 510 may be the same as relative positions between the sound sources 220, 230, and 240 and the center 211 of the multipole sound object 210 in the portion 520.

Also, since relative distances between the user and the sound sources 220, 230, and 240 decreases, the user 200 may recognize that a volume of a corresponding sound source increases although volumes of the sound sources 220, 230, and 240 are maintained.

When the relative distances between the user 200 and the sound sources 220, 230, and 240 are relatively long, the user 200 may inaccurately verify positional differences between the sound sources 220, 230, and 240. Thus, the user 20 may recognize that the relative distances between the user and the sound sources 220, 230, and 240 are close. In contrast, the user 200 may more accurately verify the positional differences between the sound sources 220, 230, and 240 according to a decrease in the relative distances between the user 200 and the sound sources 220, 230, and 240. When the user 200 verifies actual positional differences between the sound sources 220, 230, and 240, the user 200 may recognize that relative distances between the sound sources 220, 230, and 240 increase although the relative distances the sound sources 220, 230, and 240 are maintained.

In practice, when an object including a plurality of sound sources approaches a user, the user may recognize that a volume of a sound source increases and a relative distance between sound sources increases although the sound sources are not be changed.

Thus, as illustrated in FIG. 5, the sound source controller 120 may provide a realistic sound to the user by moving the sound sources 220, 230, and 240 while maintaining the relative distances between the center 211 of the multipole sound object 210 and the sound sources 220, 230, and 240.

FIG. 6 illustrates an example of changing a relative distance between sound sources included in the multipole sound object 210 according to an embodiment.

Referring to FIG. 6, a sound may be provided to the user 200 by changing a volume of the multipole sound object 210 such that the user recognizes that a relative distance between the user 200 and the multipole sound object 210 without changing a position of the multipole sound object 210.

The sound source controller 120 may decrease a volume of the multipole sound object 210 in a portion 610 as shown in a portion 620. Alternatively, the sound source controller 120 may increase a volume of the multipole sound object 210 in a portion 610 as shown in a portion 630.

For example, the sound source controller 120 may decrease relative distances between the sound sources 220, 230, and 240. In this example, according to a decrease in the relative distance between the sound sources 220, 230, and 240, the volume of the multipole sound object 210 may also decrease as shown in the portion 620. Also, the sound source controller 120 may decrease a volume of each of the sound sources 220, 230, and 240 in response to the decrease in the volume of the multipole sound object 210.

In this example, when the relative distances between the sound sources 220, 230, and 240 decrease, and when the volume of each of the sound sources 220, 230, and 240 decreases, the user 200 may recognize that a relative distance between the user 200 and the multipole sound object 210 increases.

The sound source controller 120 may increase the relative distances between the sound sources 220, 230, and 240. In this example, according to an increase in the relative distance between the sound sources 220, 230, and 240, the volume of the multipole sound object 210 may also increase as shown in the portion 630. Also, the sound source controller 120 may increase the volume of each of the sound sources 220, 230, and 240 in response to the increase in the volume of the multipole sound object 210.

In this example, when the relative distances between the sound sources 220, 230, and 240 increase, and when the volume of each of the sound sources 220, 230, and 240 increases, the user 200 may recognize that the relative distance between the user 200 and the multipole sound object 210 decreases.

Thus, the sound source controller 120 may control the volume of the multipole sound object 210 such that the user 200 recognizes that the relative distance between the user 200 and the multipole sound object 210 without changing the position of the multipole sound object 210.

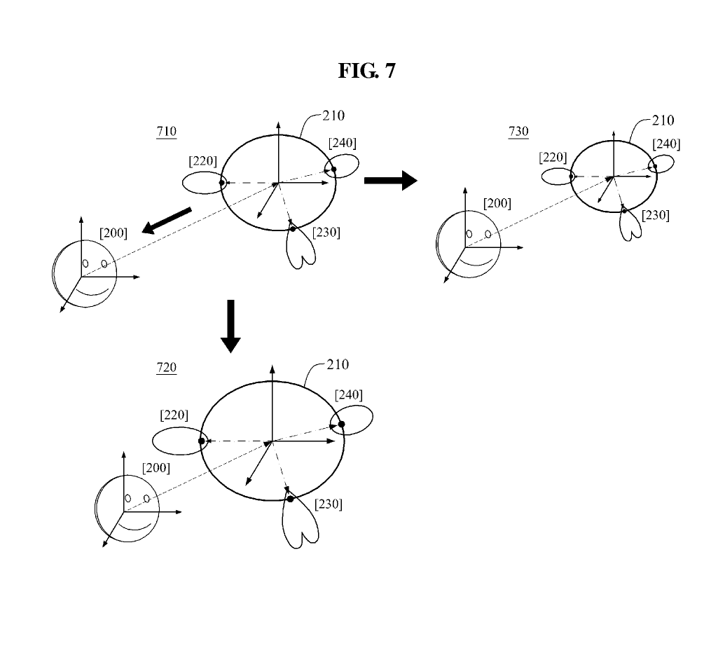

FIG. 7 illustrates an example of decreasing a relative distance between the user 200 and the multipole sound object 210 and changing a relative distance between sound sources included in the multipole sound object 210 according to an embodiment.

In a portion 710 of FIG. 7, a relative distance between the user 200 and the multipole sound object 210 may decrease by moving the multipole sound object 210 in a direction towards the user 200.

In this example, the sound source controller 120 may increase a volume of the multipole sound object 210 as shown in a portion 720. Alternatively, the sound source controller 120 may decrease the volume of the multipole sound object 210 as shown in a portion 730.

For example, the sound source controller 120 may move the sound sources 220, 230, and 240 in response to a movement of the multipole sound object 210. Additionally, the sound source controller 120 may increase relative distances between the sound sources 220, 230, and 240. In this example, according to an increase in the relative distances between the sound sources 220, 230, and 240, the volume of the multipole sound object 210 may also increase as shown in the portion 720. Also, the sound source controller 120 may increase a volume of each of the sound sources 220, 230, and 240 in response to an increase in the volume of the multipole sound object 210.

Since the relative distances between the sound sources 220, 230, and 240 increase and the volume of each of the sound sources 220, 230, and 240 increases, the user 200 may recognize that the relative distance between the user 200 and the multipole sound object 210 more decreases when compared to a case in which relative positions between a center of the multipole sound object 210 and the sound sources 220, 230, and 240 are maintained.

Thus, when the multipole sound object 210 moves in a direction towards the user 200, the sound source controller 120 may increase the relative distances between the sound sources 220, 230, and 240 while moving positions of the sound sources 220, 230, and 240 such that the user 200 recognizes that the multipole sound object 210 comes more quickly.

Also, the sound source controller 120 may decrease the relative distances between the sound sources 220, 230, and 240. In this example, according to a decrease in the relative distances between the sound sources 220, 230, and 240, the volume of the multipole sound object 210 may also decrease as shown in the portion 730. Also, the sound source controller 120 may decrease the volume of each of the sound sources 220, 230, and 240 in response to a decrease in the volume of the multipole sound object 210.

Since the relative distances between the sound sources 220, 230, and 240 decrease and the volume of each of the sound sources 220, 230, and 240 decreases, the user 200 may recognize that the relative distance between the user 200 and the multipole sound object 210 less decreases when compared to the case in which relative positions between a center of the multipole sound object 210 and the sound sources 220, 230, and 240 are maintained.

Thus, when the multipole sound object 210 moves in a direction towards the user 200, the sound source controller 120 may decrease the relative distances between the sound sources 220, 230, and 240 while moving the positions of the sound sources 220, 230, and 240 such that the user 200 recognizes that the multipole sound object 210 comes more slowly.

FIG. 8 illustrates an example of increasing a relative distance between the user 200 and the multipole sound object 210 according to an embodiment.

When the multipole sound object 210 moves from a position indicated in a portion 810 to a position indicated in a portion 820, a relative distance between the user 200 and the multipole sound object 210 may increase.

Referring to FIG. 8, the sound source controller 120 may move the sound sources 220, 230, and 240 while maintaining relative positions between the center 211 of the multipole sound object 210 and the sound sources 220, 230, and 240. For example, relative positions between the sound sources 220, 230, and 240 and the center 211 of the multipole sound object 210 in the portion 810 may be the same as relative positions between the sound sources 220, 230, and 240 and the center 211 of the multipole sound object 210 in the portion 820.

Also, since relative distances between the user and the sound sources 220, 230, and 240 increase, the user 200 may recognize that a volume of a corresponding sound source decreases although volumes of the sound sources 220, 230, and 240 are maintained.

As shown in the portion 830, when the multipole sound object 210 moves to a position at which the relative distance between the user 200 and the multipole sound object 210 exceeds a threshold, the sound source controller 120 may downmix the sound sources 220, 230, and 240 to be a sound source 831. The sound source 831 may have the directivity patterns 221, 231, and 241 of the sound sources 220, 230, and 240 with reference to FIG. 8.

FIG. 9 illustrates another example of a multipole sound object 900 according to an embodiment.

The multipole sound object setter 110 may set a multipole sound object 900 in a form differing from that of FIG. 2.

As an example, the multipole sound object setter 110 may set the multipole sound object 900 to be a sound source 910, for example, a point source, as shown in Case 1.

The multipole sound object setter 110 may set the multipole sound object 900 to be a plurality of sound sources 910 of a 1D form, for example, a line source, as shown in Case 2.

The multipole sound object setter 110 may set the multipole sound object 900 to be the sound sources 910 of a 2D form, for example, a plane source, as shown in Case 3.

The multipole sound object setter 110 may set the multipole sound object 900 to be the sound sources 910 of a 3D form, for example, a volume source, as shown in Case 4.

FIG. 10 illustrates an example of an actual object corresponding to a multipole sound object according to an embodiment.

The sound control apparatus 100 may set a sound object, for example, a vehicle 1000, having a volume and including a plurality of sound sources as a multipole sound object. Referring to FIG. 10, in the vehicle 1000, a different sound source, for example, engine noise 1010 and exhaust sound 1020, may be generated in a different position of a single object.

The sound control apparatus 100 may set the multipole sound object by arranging a sound source based on a position in which the engine noise 1010 is generated and a position in which the exhaust sound 1020 is generated based on a center of the vehicle 1000. In this example, a sound source position corresponding to the engine noise 1010 and a sound source position corresponding to the exhaust sound may vary in response to a movement and a rotation of the vehicle 1000.

Also, a user may recognize a direction and a location of the vehicle 1000 in response to a change in the sound source position corresponding to the engine noise 1010 and the sound source position corresponding to the exhaust sound 1020.

As an example, when the user recognizes that a volume of a sound source corresponding to the engine noise 1010 is greater than a volume of a sound source corresponding to the exhaust sound 1020, the user may determine that the position in which the engine noise 1010 is generated is closer than the position in which the exhaust sound 1020 is generated. In this example, relative to the vehicle 1000, the position in which the engine noise is generated may be in front of the position in which the exhaust sound 1020 is generated.

Accordingly, the user may recognize that the vehicle 1000 moves in a direction toward the user.

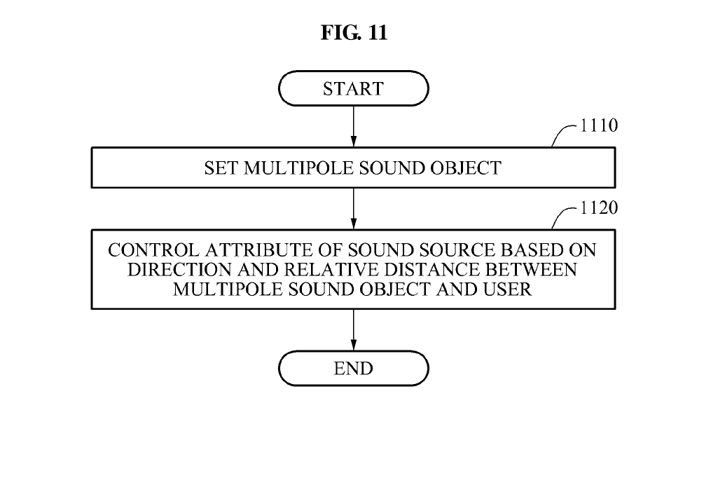

FIG. 11 is a flowchart illustrating a sound control method according to an embodiment.

In operation 1110, the multipole sound object setter 110 may set a multipole sound object including at least one sound source.

In this example, the multipole sound object setter 110 may set the multipole sound object using a sound source and at least one directional characteristic of the sound source. Also, the multipole sound object setter 110 may arrange a plurality of differing sound sources included in the multipole sound object, and set the multipole sound object based on a directional characteristic of each of the sound sources. In this example, a number of sound sources arranged based on a position of the multipole sound object may be changeably determined as necessary.

In operation 1120, the sound source controller 120 may control an attribute of a sound source included in the multipole sound object based on a direction and a relative distance between the multipole sound object and a user. In this example, the sound source controller 120 may control the attribute of the sound source by controlling a relative distance between sound sources, directional characteristics, and a position of the sound source in response to a change in a relative distance between the multipole sound object and a user, a position to which the multipole sound object rotates based on the user, or a rotation of the multipole sound object.

As an example, when the multipole sound object rotates, the sound source controller 120 may rotate the position of the sound source and the directional characteristic of the sound source based on a center of the multipole sound object. When the multipole sound object rotates based on the user, the sound source controller 120 may move the position of the sound source and the directional characteristic of the sound source based on the position to which the multipole sound object rotates. Also, in response to a change in the relative distance between the multipole sound object and the user, the sound source controller 120 may move the position of the sound source and the directional characteristic of the sound source based on the change in the relative distance between the multipole sound object and the user.

Also, the sound source controller 120 may control a volume of the multipole sound object by controlling relative distances of a plurality of sound sources.

According to example embodiments, a sound object having a volume and including a plurality of sound sources may be set as a multipole sound object in which each sound source to has a relative position and directivity, thereby accurately representing a realistic sound. As an example, when a multipole sound object approaches a user, a sound may be provided to the user such that the user spatially distinguish a plurality of sounds included in the multipole sound object based on an increased volume of the sound. Also, a position of a sound source may be controlled based on a relative distance between the multipole sound object and the user, thereby accurately representing a sound image of the sound source included in the multipole sound object.

According to example embodiments, it is possible to accurately represent a realistic sound of a sound object having a volume and including a plurality of sound sources by setting the sound object as a multipole sound object in which each sound source has a relative position and a directional characteristic.

The above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present disclosure, or vice versa.

While this disclosure includes specific examples, it will be apparent to one of ordinary skill in the art that various changes in form and details may be made in these to examples without departing from the spirit and scope of the claims and their equivalents.

Therefore, the scope of the disclosure is defined not by the detailed description, but by the claims and their equivalents, and all variations within the scope of the claims and their equivalents are to be construed as being included in the disclosure.

What is claimed is:

1. A sound control method comprising:
setting a multipole sound object including at least one sound source; and
controlling an attribute of a sound source included in the multipole sound object based on a direction and a relative distance between the multipole sound object and a user.

2. The method of claim 1, wherein the setting comprises setting the multipole sound object based on a sound source and at least one directional characteristic of the sound source.

3. The method of claim 1, wherein when the multipole sound object rotates, the controlling comprises rotating a position of the sound source and a directional characteristic of the sound source based on a center of the multipole sound object.

4. The method of claim 1, wherein when the multipole sound object rotates based on the user, the controlling comprises moving a position of the sound source and a directional characteristic of the sound source based on a position to which the multipole sound object rotates.

5. The method of claim 1, wherein when the relative distance between the multipole sound object and the user changes, the controlling comprises moving a position of the sound source and a directional characteristic of the sound source based on a change in the relative distance between the multipole sound object and the user.

6. The method of claim 1, wherein the setting comprises arranging a plurality of sound sources based on a position of the multipole sound object and setting the multipole sound object using directional characteristics of the sound sources.

7. The method of claim 6, wherein the controlling comprises controlling a relative distance of the plurality of sound sources to control a volume of the multipole sound object.

8. The method of claim 6, wherein when the relative distance between the multipole sound object and the user exceeds a threshold, the controlling comprises downmixing the plurality of sound sources to be one sound source and expressing the multipole sound object based on the one sound source and at least one directional characteristic of the one sound source.

9. The method of claim 1, wherein the setting comprises setting the multipole sound object in a form of a line source by arranging a plurality of sound sources in a one-dimensional (1D) form.

10. The method of claim 1, wherein the setting comprises setting the multipole sound object in a form of a plane source by arranging a plurality of sound sources in a two-dimensional (2D) form.

11. The method of claim 1, wherein the setting comprises setting the multipole sound object in a form of a volume source by arranging a plurality of sound sources in a three-dimensional (3D) form.

12. A sound control apparatus comprising:
a multipole sound object setter configured to set a multipole sound object including at least one sound source; and
a sound source controller configured to control an attribute of a sound source included in the multipole sound object based on a direction and a relative distance between the multipole sound object and a user.

13. The apparatus of claim 12, wherein the multipole sound object setter is configured to set the multipole sound object based on a sound source and at least one directional characteristic of the sound source.

14. The apparatus of claim 12, wherein when the multipole sound object rotates, the sound source controller is configured to rotate a position of the sound source and a directional characteristic of the sound source based on a center of the multipole sound object.

15. The apparatus of claim 12, wherein when the multipole sound object rotates based on the user, the sound source controller is configured to move a position of the sound source and a directional characteristic of the sound source based on a position to which the multipole sound object rotates.

16. The apparatus of claim 12, wherein when the relative distance between the multipole sound object and the user changes, the sound source controller is configured to move a position of the sound source and a directional characteristic of the sound source based on a change in the relative distance between the multipole sound object and the user.

17. The apparatus of claim 12, wherein the multipole sound object setter is configured to arrange a plurality of sound sources based on a position of the multipole sound object and set the multipole sound object based on directional characteristics of the sound sources.

18. The apparatus of claim 17, wherein the sound source controller is configured to control a relative distance of the plurality of sound sources to control a volume of the multipole sound object.

19. The apparatus of claim 17, wherein when the relative distance between the multipole sound object and the user exceeds a threshold, the sound source controller is configured to downmix the plurality of sound sources to be one sound source and express the multipole sound object based on the one sound source and at least one directional characteristic of the one sound source.

20. The apparatus of claim 12, wherein the multipole sound object setter is configured to set the multipole sound object in a form of a volume source by arranging a plurality of sound sources in a three-dimensional (3D) form.
